(19) United States
(12) Patent Application Publication
(10) Pub. No.: US 2016/0297149 A1
(43) Pub. Date: Oct. 13, 2016

(54) SYSTEM, APPARATUS, AND METHOD FOR 3D SCANNING AND PRINTING

(71) Applicant: FunFare, LLC, Redwood City, CA (US)

(72) Inventors: Charles ALBERT, Redwood City, CA (US); David G. CAPPER, Novato, CA (US); Andrew S. FILO, Cupertino, CA (US)

(21) Appl. No.: 15/094,657

(22) Filed: Apr. 8, 2016

Related U.S. Application Data
(60) Provisional application No. 62/144,490, filed on Apr. 8, 2015.

(51) Int. Cl. B29C 67/00; G05B 19/4099

(52) U.S. Cl. CPC B29C 67/0088; G05B 19/4099; B33Y 50/02

(57) ABSTRACT

A system, apparatus, and method for 3D scanning and printing that includes a 3D printer device with a rotatable platform that can be controlled by an associated 3D image scanning device. The scanning device can be a smart phone or the like and can generate commands to move the rotatable platform of the printer in association with scanning operation. The smart phone can be detachably coupled to the 3D printer and perform the scan through an aligned aperture. The touch screen of the phone can serve as a control and status interface for the scanning operation. The resulting scan can be stored in a cloud based service where 3D processing can be further applied. The processed 3D printer file can be accessed by other devices connected to the cloud service. An object can thereby be scanned at one 3D printer location and sent to another 3D printer location via the cloud connection or a peer-to-peer network.

### CROSS-REFERENCE TO RELATED APPLICATIONS

This application claims priority of U.S. Provisional Application No. 62/144,490, entitled “Smart Phone Enable Accessory for 3D Scanning and Printing,” filed Apr. 8, 2015, which is incorporated herein by reference in its entirety for all purposes.

### FIELD OF THE INVENTION

The present invention relates to a system for using a portable device, such as a smart phone, in conjunction with a 3D printer to scan and print 3D objects. More specifically, the present invention relates to associating the computing and scanning power of the portable device with a 3D printer that interacts with the portable device.

### BACKGROUND OF THE INVENTION

3D printers are becoming more common in manufacturing and home environments with the creation of lower cost printing devices. 3D printers can receive files of objects to be printed that have been scanned, configured, and stored in a central database area. Large libraries of such objects exist in the public domain for use in 3D printing. Additionally, the 3D printer can receive data regarding an object to be printed from a scanner that scans an object and sends the information to the printer. Such object scanners come in many different forms and configurations. Some object scanners have a spinning platform and an integrated camera (or cameras) for capturing the object. Other scanners are hand-held and require the user to move around the object and create multiple images in order to facilitate forming a 3D image.

In each instance, such scanners function separately from the 3D printer device, and do not take advantage of mechanical motion that can be provided by the 3D printer itself. The individual scanner requires separate cameras, processors, memory, and motion control (either mechanical or manual). Alternatively, various portable image capture devices exist, such as a smart phone, which can provide a large amount of computing power, along with a high resolution camera, memory, wireless and wired communications, and a touch-screen interface for initiating and controlling a scan. The redundancy and cost of requiring a separate scanning device, i.e., having separate scanning and motion components, is not a cost effective implementation.

Accordingly, a 3D scanning and printing solution is described herein which interfaces a 3D printer with a portable image capture device to thereby incorporate the power, capabilities, and features of the portable device, while providing a movable scanning platform to facilitate the scan by the portable image capture device.

### SUMMARY OF THE INVENTION

To achieve the foregoing and in accordance with the purpose of the present invention, a 3D printing and scanning system is provided which interfaces a 3D printer device with a portable image capture device, such as a smart phone, to facilitate the generation of a 3D scan. The 3D scan can be used by the proximate 3D printing device that is facilitating the scan. The 3D scan can also be used by other 3D printing devices that might be associated via a network or transmission of the scanned object data.

According to one aspect of the present invention, a 3D printing and scanning system is provided that enables scanning of an object using a 3D printer device in association with a portable image capture device, the system comprising: a 3D printer device having a rotatable platform for holding an object to be scanned; a portable image capture device proximally associated with the 3D printer device; a control signal communicated from the portable image capture device to the 3D printer device for controlling the rotation of the platform while a scan of the object is being performed by the portable image capture device; and a 3D printer file resulting from the scan.

According to another aspect of the present invention, a 3D scanning and printing apparatus is provided that enables a 3D scanning operation to be performed on the printer in association with a coupled 3D image scanning device, the apparatus comprising: a 3D printer having a rotatable platform and being configured to receive commands to rotate the platform in response to a scan being performed; a detachably coupled 3D image scanner associated with the 3D printer, the scanner configured to generate commands to rotate the 3D printer platform in response to a scan being performed.

According to yet another aspect of the present invention, a 3D scanning and printing method is provided that enables a 3D scanning operation to be performed on a 3D printer that is associated with a 3D image scanning device, the method comprising the steps of: placing an object to be scanned on a rotating platform of the 3D printer; coupling a 3D image scanning device to the 3D printer; generating commands to be sent from the 3D image scanning device to the 3D printer for controlling motion of the rotating platform; scanning the object with the 3D image scanning device; and outputting a 3D printer file.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures and the accompanying drawings in which reference numerals refer to various elements, and in which:

FIG. 1A shows a perspective view of a system having a 3D printer device with an associated portable image capture device, i.e. smart phone, in communication with the 3D printer device to facilitate generating a scan.

FIG. 1B shows a representative 3D file being stored in a cloud services type environment.

FIG. 1C shows a representative receiving device (smart phone) or 3D printer at a different location that connects to the cloud services information for receiving the 3D file.

FIG. 2A shows a diagram of a representative 3D printer according to a particular embodiment of the present invention

FIG. 2B shows a diagram of the platform assembly illustrated in FIG. 2A.

FIG. 3 shows an illustration of some components of the representative 3D printer.

FIGS. 4A-4C show diagrams indicating movements of the 3D printer platform according to a particular embodiment of the present invention.

FIG. 5 shows a representative cloud service network with various devices interacting with the cloud.

FIG. 5A shows a representative peer-to-peer network with devices interacting through a telecom network.

FIG. 6 shows a representative 3D printer having a mounting frame and aperture to facilitate using the portable image capture device to generate a scanned image.

FIG. 7 shows a representative set of control and status information that might be interactively shown on the touch screen interface.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, certain structures or components may not have been described in detail in order to not unnecessarily obscure the present invention.

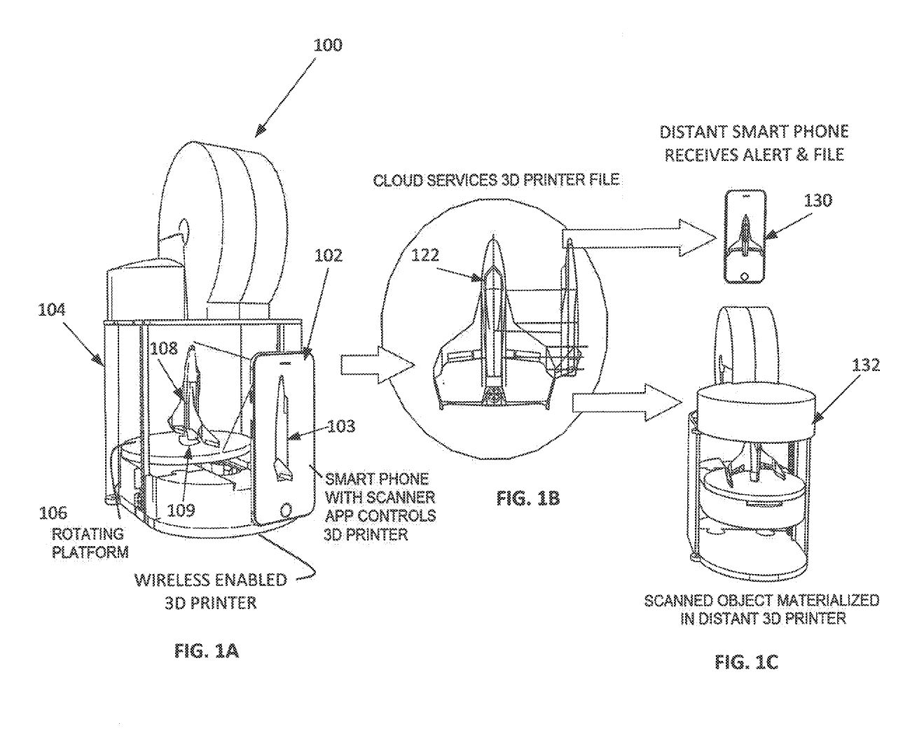

With reference to FIG. 1A, a representative 3D scanning and printing device 100 is shown. The following embodiments show a smart phone being used as the portable image capture device, but this is meant to serve as a representative example. Any of a variety of other portable image capture devices could also be readily used. The smart phone is shown because it provides a readily available device having considerable computer processing power and memory storage capabilities. The smart phone also provides, among other things, wired and wireless capabilities for the transmission of data, as well as a proven touch-screen interface for interacting with the user.

FIG. 1A also shows a representative 3D printer 104 that is based on a polar coordinate style architecture. This polar coordinate printer uses a rotational bed 106 that rotates on the theta axis, and also slides in a transverse radial direction (‘R’) to achieve 2-dimensions of motion. The third ‘z’ axis is in the vertical direction and provides the third degree of motion. The 3D printed object is formed on the rotating bed via layers of extruded material being deposited according to an input control file. The input file represents a 3D object to be formed and provides control information for the motion of the bed and the timing of the extruded material to be deposited onto the bed. While a polar coordinate printer is shown, other types of printers using alternative coordinate systems could also be used according to the present embodiments. For instance, the printer could also operate under a cartesian or delta or other coordinate system. By way of providing background examples of 3D printer configurations, this application also incorporates by reference U.S. Provisional Application 62/126,876, entitled “Rapid Coupling, Cartridge Based Passive Thermal Transduction Extruder for 3D Printing,” filed Mar. 2, 2015, and U.S. Utility application Ser. No. 15/059,187, entitled “Three Dimensional Printer and Cartridge,” filed Mar. 2, 2016.

A smart phone 102 is shown associated proximate to the 3D printer 104. The smart phone could operate detached and located close to the 3D printer, or be attached or connected (detachably or otherwise) in any of a variety of ways. Depending upon the orientation and placement of the phone, either the front facing camera or the rear facing camera could be used for the scanning operation. In the scanning mode, an object 108 is placed or temporarily fixed to the rotating platform 106. A holding device or means 109 is also shown for holding the object 108 in a steady position on the platform 106. This holding device or means can include, but is not limited to, tape, adhesive, glue, clay, a bed of plastic finger pins, a clamp, or a 3D print holder. The smart phone 102 communicates with the 3D printer 104 via a wired or wireless connection between the devices. Wireless connections can include, for instance WiFi, Bluetooth, or ultrasound. Wired connections can include, for instance, USB, Ethernet, Firewire, or other such connections.

An application (“app”) 103 or scanning program running on the smart phone is initiated to scan and capture the object on the rotating platform 106. Examples of such apps might include: TRNIO, 123D Catch, Volumental, Trimensional, Itseez3D, and MobileFusion. The app 103 will communicate with the 3D printer 104 via the wired or wireless connection wherein a control signal is applied to the 3D printer to initiate rotation of the platform 106. For instance, once the app is initiated on the smart phone, instructions in the form of G code are sent to the 3D printer to incrementally rotate the object while the camera in the smart phone records these images. The smart phone's high resolution camera in conjunction with the controlled rotation of the platform then serves to create a 3D printer file of the scanned object 108.

Movement of the platform across the radial direction R can also be initiated to bring the object closer (or farther away) from the smart phone camera in order to fine-tune the resulting 3D scan. If a 3D object to be scanned has a complex shape, i.e., with undercuts or the like, it becomes advantageous to perform a scan that involves multiple distances (R) in conjunction with various rotational angles (theta). Control signals would be provided from the smart phone based app to the 3D printer to initiate the appropriate rotational and radial motion of the object 108 in order to achieve the desired scan.

Accordingly, the physical movement provided by the 3D printer 104, i.e., movement which is normally used for printing a 3D object, is now used in conjunction with the smart phone 102 and smart phone app to create a 3D printer file of the object 108. The smart phone's processing power can also serve to perform the complex operations needed to render and create the 3D printer file. Additionally, the smart phone's memory can provide adequate internal memory for storage of the resulting information. Moreover, supplementary lighting can be provided via the smart phone's built-in flash module for rear-facing camera usage. For front facing camera usage, light being emitted (either ambiently or purposefully) from the smart phone's screen could be used.

Referring now to FIG. 1B, the 3D printer file 120 is representatively shown as being sent and/or stored in a cloud services based environment. The resulting images are uploaded to the cloud based service for access by anybody with access to those cloud files. The cloud service can include, for instance, a multibank computer client that is proprietary to the 3D printer user. Alternatively, the cloud can include any of a variety of cloud based services being offered by a variety of companies (i.e., Microsoft, Amazon, Apple).

The 3D printer file 120 can be fully processed by the smart phone 102 before being sent to the cloud, depending upon the processing power of the smart phone and the complexity of the object. Conversely, further processing of the images 122 may be needed in order to fully derive the geometries desired in the 3D printer file. In some instances, part of the geometry can be inferred during processing, i.e., parts that were not visible to the camera, or perhaps parts that were too shiny or not properly lit during the scanning operation. Client software, such as Vectary, MIL, and 123D Catch, can be used to fill in such gaps or correct such information automatically, or as needed. Various post-processing of the file can also be offloaded for performance in the cloud, thereby freeing up processing resources in the smart phone or other such image capture devices.

Referring now to FIG. 1C, the resulting 3D printer file is received from the cloud by the intended receiving device. Such devices can include, for instance, a distant smart phone 130 or a 3D printer 132. In addition, once post-processing is performed (if required) in the cloud or otherwise, then the same smart phone that is sending the 3D information can later pick up the completed file. Alternatively, any other device can also pick up the completed file, including other smart phones, computing devices, and/or 3D printers connected to the cloud.

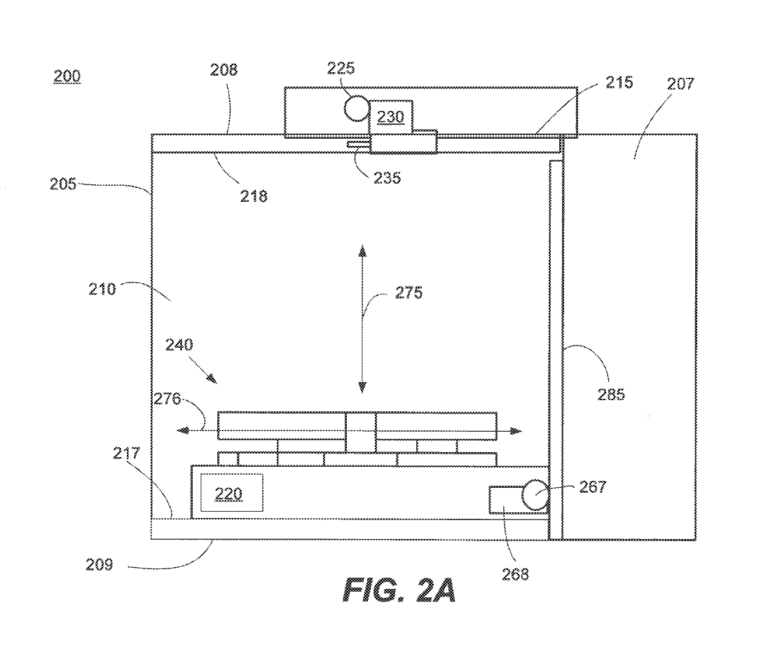

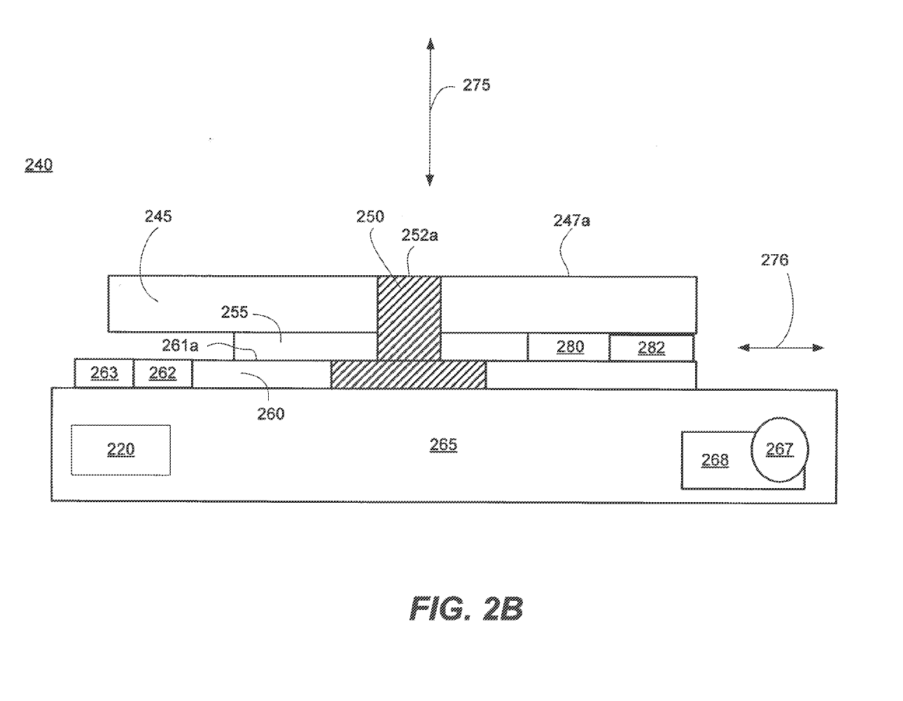

Referring to FIGS. 2A and 2B, a representative three dimensional printer 200 according to a particular embodiment of the present invention will be described. The 3-D printer 200 may be any suitable printer that is arranged to form objects using any known three dimensional printing technique e.g., additive manufacturing, fused deposition modeling, etc. The 3-D printer 200 may be, for example, the printer 104 as shown in FIG. 1. The printer 200 includes a housing 205, an inner compartment 210, a cartridge interface 215 and a platform assembly 240. Near or at the cartridge interface 215 is a feed pinion 225, feed gear motor 230 and a heating element 235. As indicated in FIGS. 2A and 2B, the platform assembly 240 includes a platform 245, a contact 250, a platform turning mechanism 255, slider 260, a table 265, a control system 220 and associated motors and gears. It should be appreciated that the illustrated printer is intended to be exemplary and non-limiting, and that a wide variety of different printer systems (e.g., Cartesian, polar coordinate, etc.) with fewer or more components may be used.

The housing 205 is arranged to protect and/or encase internal components of the printer 200. The housing 205 may be made of any suitable material, including but not limited to plastic and metal. In various embodiments, the housing 205 includes a door 207 that can be opened to obtain access to the inner compartment 210.

The housing 205 and the printer 200 may take a wide variety of different forms. In the illustrated embodiment, for example, the housing 205 has opposing top and bottom surfaces 208/209. The top surface 208 is the location at which a cartridge interfaces with the printer e.g., the location of cartridge interface 215, feed pinion 225 and the heating element 235. The bottom surface 209 is arranged to be placed on an underlying surface e.g., the floor or a table. This above design is intended to be exemplary, however, and it should be appreciated that the housing 205 and the printer 200 may have any suitable arrangement, configuration and/or shape.

The inner compartment 210 is arranged to be a space within the housing 205 in which printing takes place. In the illustrated embodiment, the platform assembly 240, which includes a platform 245, a slider 260 and a table 265, rests on a bottom surface 217 of the compartment. The opposing top surface 218 of the compartment 210 shares a housing wall with the cartridge interface 215 and/or is arranged to help physically support a nozzle assembly of a cartridge, so that deposition material can be dispensed over the platform 245 through the nozzle assembly.

The platform 245 is any suitable structure that is arranged to receive deposition material dispensed from the nozzle assembly. In the illustrated embodiment of FIGS. 2A and 2B, for example, the printer 200 is positioned such that deposition material is dispensed directly onto a top surface 247a of the platform 245 to form the desired object. The platform 245 may be of any suitable size and shape. In various implementations, the top surface 247a of the platform is circular.

As shown in FIG. 2B, a contact 250 is positioned on the platform 245. The contact 250 may be any structure, mechanism or device on the platform that is arranged to help generate a signal when it is touched e.g., by the nozzle of the nozzle assembly. In the illustrated embodiment, for example, the contact 250 is a mechanical button that extends at least partially through the platform. In other embodiments, the contact 250 is or includes an electrical contact, a capacitive sensor, a magnetic sensor or any other suitable type of sensor arranged to detect the touching or proximity of an object (e.g., the nozzle.) In various implementations, the contact 250 is a structure physically separate from the platform, while in other implementations, it forms a part of or is integrated into the platform.

In the illustrated embodiment, for example, the contact/button extends entirely through the platform 245, the platform turning mechanism 255 and at least partially through the slider 260. Put another way, there are apertures in the platform and platform turning mechanism that are aligned with one another, thus allowing the contact/button to extend through them. In this example, the top surface 247a of the platform 245 and the top surface 252a of the contact/button are coplanar. Additionally, the top surface of the contact/button is exactly at the center of the circular, top surface of the platform. In other designs, however, the contact and platform may have different arrangements. For example, in some implementations, the contact 250 may not extend entirely through the platform 245 and/or may be situated in a recessed region in the platform.

The contact 250 is coupled with the control system 220. When the contact 250 is touched and/or when the contact/sensor detects the proximity of a particular object (e.g., the nozzle of a cartridge), it is arranged to generate a signal. The control system 220 receives the signal and, in response, sends commands to other components in the printer 200. As will be discussed in greater detail later in the application, the control system 220 determines the proper position of the nozzle relative to the top surface of the platform in part based on the signal.

In the example illustrated in FIGS. 2A and 2B, underlying the platform 245 is a platform turning mechanism 255. The platform turning mechanism is arranged to physically support and/or rotate the platform e.g., around the Z axis 275. In some embodiments, the platform turning mechanism is a circular, rotatable gear. A platform turning gear 280 engages the platform turning mechanism and drives its rotation. A platform turning motor 282 provides power to and drives the platform turning gear 280. In this example, the platform 245 is fixedly attached with the underlying platform turning mechanism 255, so that when the platform turning mechanism 255 rotates, the platform rotates as well.

In this example, the platform turning mechanism 255 is sandwiched between the platform 245 and the slider 260. The slider 260 is any suitable structure that is arranged to help move the platform along an R axis 276 i.e., a lateral axis that is perpendicular to the Z axis. (Note that in some embodiments, the R axis may also be extending directly out of the page, rather than across the page.) In various embodiments, the platform 245 and/or the platform turning mechanism 255 are fixedly attached with the top surface 261a of the slider 260, so that when the slider moves, the platform and/or the platform turning mechanism move in tandem. A slider gear 262, which is driven by the slider motor 263, is physically engaged with the slider 260. When the slider gear 262 is powered by the motor 263, the slider gear 262 rotates, which causes the slider 260 to move along the R axis.

The table 265 is any suitable structure arranged to help physically support, raise and lower the overlying platform 245, platform turning mechanism 255 and/or the slider 260. In the illustrated embodiment, for example, the table 265 is fixedly attached with a Z axis gear 267, which is powered by a Z axis motor 268. The Z axis gear 267 engages a rail 285 that extends in a direction parallel to the Z axis 275. When the Z axis gear is rotated, the table 265 and other components that overlie the table (e.g., the platform 245, the platform turning mechanism 255 and the slider 260) move upward or downward within the compartment i.e., along the Z axis 275.

The table 265 may have a variety of designs. For example, in the illustrated embodiment, the table 265 is at least partially hollow and contains an internal space. In the space are circuitry, memory and/or one or more processors that make up the control system 220. (Note that in some designs, the control system 220 may be positioned in a different location of the printer.) Other components (e.g., motors or gears) may also be situated in the space within the table.

On one or more exterior surfaces of the housing 205 of the printer 200 is a cartridge interface 215. The cartridge interface 215 is any structure arranged to engage with the printer. Any suitable locking or attachment mechanism may be used in the cartridge interface. In some implementations, for example, the cartridge interface 215 includes a rail, a slot, a latch, a fastener or some other attachment/connecting apparatus. Generally, the cartridge interface 215 helps to securely attach the cartridge with the printer, as well as help properly position the cartridge so that printing can begin using the deposition material and nozzle assembly in the cartridge.

The heating element 235 is any suitable structure in the printer 200 used to heat deposition material in the cartridge. The heating of the deposition material is performed so that the formerly solid deposition material can be put into a state such that it can be easily dispensed from the nozzle assembly of the cartridge. Generally, the heating element 235 is arranged to engage the heater receiving element of the cartridge. For example, the heating element 235 may be a tube or structure that is arranged to extend through an opening in the cartridge housing such that it is positioned adjacent to the tube or nozzle of the nozzle assembly in the cartridge. The heating element 235 generates heat, which helps melt deposition material in the tube or nozzle.

The heating element 235 may have a wide variety of designs. In some implementations, for example, the heating element 235 includes a hollow tube made of a thermally conductive material e.g., metal. Inside a space within the tube is a (metallic) wire or coil. To generate heat, the 3-D printer 200 runs a current through the wire. There may also be a temperature sensor attached on the outside or inside of the heating element 235, so that the control system 220 of the printer 200 can determine whether a predetermined, desired temperature has been reached.

The control system 220 of the printer 200 may adjust the temperature of the heating element, depending on the type of deposition material used. For example, if PLA is used as a deposition material, in various embodiments, the printer may heat the heating element to a temperature of over 150° F. or between 170 and 230° F. if ABS is used, the printer may be arranged to heat the heating element to a temperature of over 220° F. or between 220 and 280° F. Generally, the printer may heat the heating element to a wide range of temperatures e.g., whatever temperature is needed to change deposition material to a plastic or glass state at a desired rate.

The heater element 235 may be positioned in a variety of locations and configurations. For example, the heater element 235 may be exposed outside of the housing of the printer. In other embodiments, the heater element 235 is positioned within the housing, but is accessible through a door or opening in the housing 205.

The printer also includes a feed pinion 225. The feed pinion 225 is a gear or other structure that is arranged to engage the feed gear on the cartridge and help drive the filament/deposition material through the nozzle assembly of the cartridge. In various embodiments, the feed pinion 225 is exposed outside of the housing 205 of the printer 200, so that it has easy access to the cartridge. In other embodiments, the pinion 225 is within the housing, but is accessible through a door or opening in the housing. In the illustrated embodiment, the feed pinion 225 is driven by a feed pinion motor 230.

The feed pinion 225 and/or feed pinion motor 230 may be positioned in various locations on the printer. In the illustrated embodiment, for example, the feed pinion 225 and the feed pinion motor 230 are positioned on a top side/surface 208 of the printer. When the cartridge is inserted into or engaged with the top side of the printer, the feed pinion 225 is in a position to engage the feed gear of the cartridge.

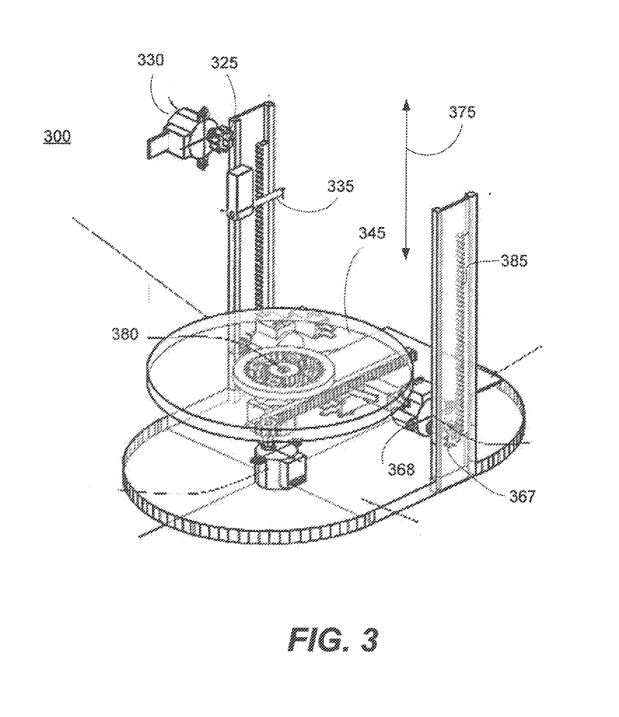

Referring next to FIG. 3, a perspective view of selected internal components of a 3-D printer according to a particular embodiment of the present invention is described. FIG. 3 illustrates a 3-D printer 300 (which may have any of the features and components of the printer described in the incorporated references) that includes a feed pinion 325, feed gear motor 330, a heating element 335, a platform 345 and rails 385 for vertically raising and lowering the platform. For illustrative purposes, the platform 345 is transparent so that the underlying platform turning mechanism 380 can be seen.

In this particular embodiment, the platform 345 is circular and is centered over the underlying platform turning mechanism 380, which is also circular. The platform 345 is fixedly attached with the platform turning mechanism 380 so that when the mechanism rotates, the platform rotates.

The platform 345 is also attached with a Z axis gear 367, which is driven by a Z axis motor 368. When the Z axis motor 368 causes the Z axis gear 367 to rotate, the gear 367 moves along the rail 385 along the Z axis 375, together with the platform 345.

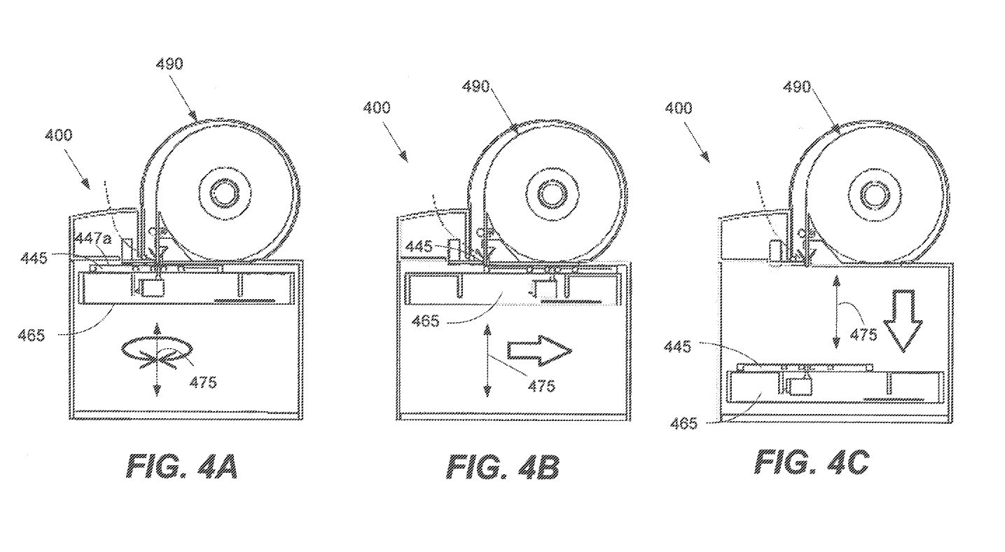

Referring next to FIGS. 4A-4C, various side views of a 3-D minter 400 and a cartridge 490 according to a particular embodiment are described. The printer 400 may have any of the features or components of other printers described herein (e.g., printer 200 of FIG. 2.) FIGS. 4A-4C illustrate various ways in which a platform 445 and/or connected components (e.g., a platform turning mechanism, a slider and a table) may be moved within the compartment of the printer. In the illustrated embodiment, the printer 400 includes a platform 445 and a table 465. The table 465 underlies and helps physically support the platform 445.

In FIG. 4A, the platform 445 is rotating, as indicated by the arrows. More specifically, it is rotating around a Z axis 475 that extends vertically up through the printer i.e., an axis that extends perpendicular to the top surface 447a of the platform 445. It should be noted that in this example, the table is not necessarily rotating. Rather, there may be a gear (e.g., platform turning mechanism, which is not shown) that is sandwiched between the table and the platform. The platform 445 is attached to the gear and rotates in tandem with the gear, while the table remains still and/or does not rotate.

In FIG. 4B, the platform 445 is moving in a lateral direction i.e., in a direction that is perpendicular to the Z axis 475. In this example, the table 465 is not necessarily moving in the same direction. There is a structure (e.g., a slider, which is not shown) that is sandwiched between the table 465 and the platform 445. The slider is fixedly attached with the platform, such that when the slider moves in the lateral direction, the platform 445 moves laterally in tandem, while the table remains still.

FIG. 4C indicates that the platform 445 is capable of being raised and lowered. (In FIGS. 4A and 4B, the platform was in a raised position, and in FIG. 4C it has been lowered.) The raising and lowering involves moving the platform vertically along the Z axis 475. In this example, the table 465 is capable of moving up and down as described above. Since the platform 445 rests on the table 465, the platform moves up and down in tandem with the table.

Any of the movements described above may be driven by various gears and motors described in connection with FIG. 2A and 2B. For example, the vertical raising and lowering of the platform may be performed using the Z axis gear 267, Z axis motor 282 and the table. The lateral movement of the platform may be performed using the slider gear 262, the slider motor 263 and the slider 260. The rotation of the platform may be performed using the platform turning mechanism 255, the platform turning motor 282 and the platform turning mechanism 255.

In operation, a user of a 3D printer usually designs or selects a pre-existing 3D object that they wish to print. Typically this is an STL (Stereolithography) file (for instance, FILENAME.STL). STL is a file format native to stereolithography CAD software systems, and for many years now the STL file has served as a bridge between 3D CAD design systems and 3D printer hardware. In practice, to successfully design an object in 3D software requires experience, skill, and practice. Accordingly, good and viable pre-existing object files are often limited in their availability and suitability.

When scanned, the object is figuratively sliced by the computing or processing device into a series of layer commands that in turn will be used by the 3D printer to drive the actions of the motors and heated print nozzle. The resulting object is printed as a series of successive 2-dimensional layers. The layers are sequentially printed on top of one another to create a 3-dimensional object out of material that is extruded from the print nozzle. To initiate a 3D print job, the user would therefore connect the 3D printer to a computer, via a wired USB cable in order to download the object file to be printed. Alternatively, the file might be transferred to the printer wirelessly or via a memory card.

Rather than download an existing file from a database, a user may wish to directly scan an object for a variety of reasons. The object might be unique and unavailable as a pre-existing file in a 3D file database. Additionally, the object can be complex and modeling it into a printable file is not easy, and hence such files are not readily available. Moreover, the user may wish to share, sell, or trade their scanned items with another user. Accordingly, direct scanning of the object is often needed or desired, and the present configuration allows the user to leverage the power and capabilities of their existing smart phone with their 3D printer, which can provide controlled motion to facilitate the object scan.

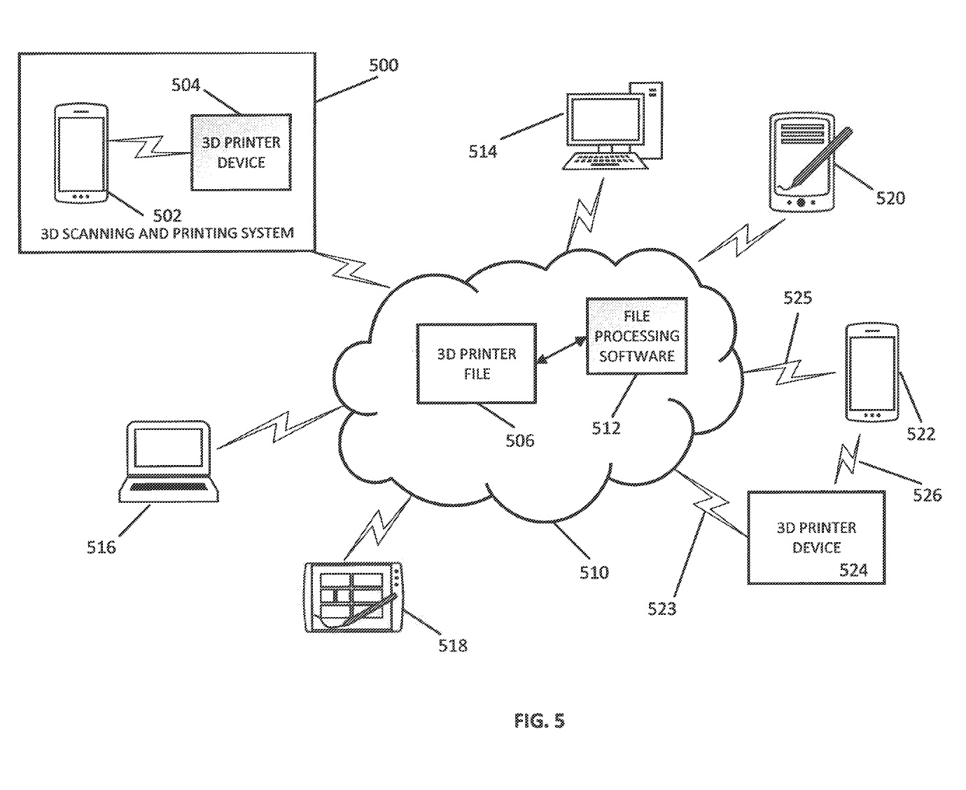

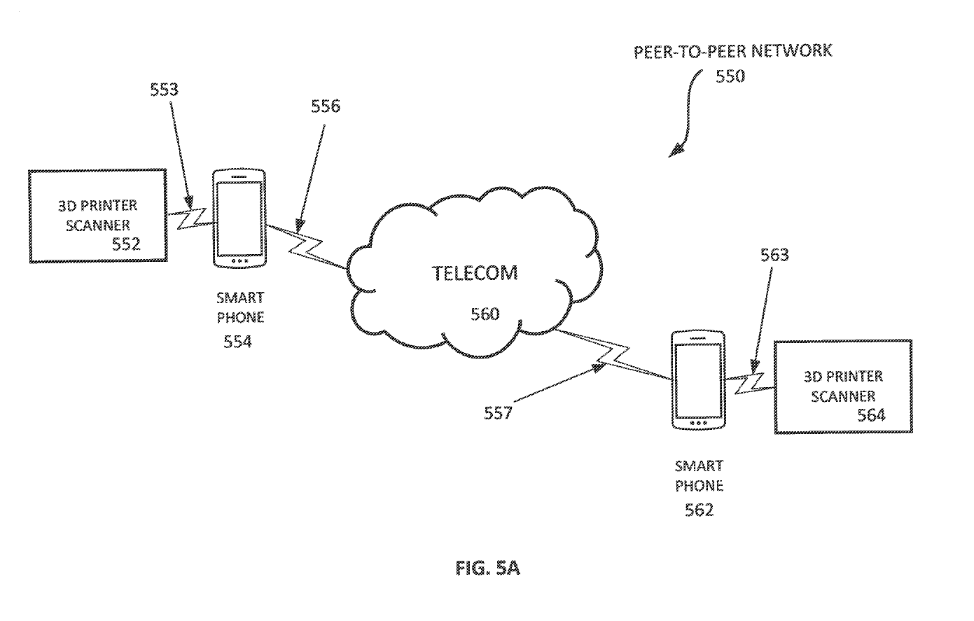

Referring to FIG. 5, further aspects of the system interacting with a cloud service and associated cloud based devices are shown. A 3D scanning and printing system 500 is shown including a smart phone 502 associated with a 3D printer device 504. When a scan is completed by the system 500, a 3D printer file 506 is generated. If the smart phone has enough computing power, then the 3D printer file can be completely processed on the smart phone device. The resulting 3D printer file can thereafter be sent and stored in the cloud, or in a database or the like, for access by any other connected devices.

The cloud service can be configured to also include cloud based file processing software 512 which can perform further processing on the 3D printer file 506. Processing can be applied that uses, for instance, photogrammetry to incrementally deduce the 3D mesh network of the surface of the object. Cloud service processing can also be used to repair and condition the mesh from any defects that might have occurred during scanning Alternatively, an external computing device such as a computer 514 or laptop 516 can be used to download the partially processed 3D printer file, and then further processing can be done resident to the computer 514 or laptop 516. After the 3D printer file 506 is fully processed, then it can be uploaded again to the cloud 510 for use by other devices that are connected, or have access to the cloud. Examples of such other devices include a computer 514, laptop 516, tablet 518, PDA (Personal Data Assistant) 520, or smart phone 522.

The 3D mesh object is then sliced into layers and G code is generated that will be used by the 3D printer to print the object. The resulting G code can be sent to a receiving smart phone or 3D printer via wireless or wired connection or otherwise. Once the scanned 3D printer file is received at a destination, it can be used to generate a 3D print and the object will be formed at the destination 3D printer.

For instance, further shown is a 3D printer device 524 which is connected to the cloud for receiving the fully processed 3D printer file 506. According to this example, an object is placed on the rotating platform of the 3D printer device 504 and a scan is initiated via the touch screen interface of the associated smart phone 502. The rotating platform will move (or turn) in response to commands being sent to the 3D printer device 504 from the associated smart phone 502, and the camera on the smart phone will perform a scan of the object. The resulting 3D printer file 506 can be sent to the cloud 510. Further file processing via 512 can be applied if needed. Once the file is fully processed, it can then be sent to the 3D printer device 524 via connection 523. The destination 3D printer device 524 would typically be located remote-from (or non-proximate to) the 3D scanning and printing system 500. The processed 3D printer file 506 can also be sent to a smart phone 522 via connection 525, and then that smart phone 522 can be used to convey the 3D printer file 506 via connection 526 to the distant 3D printer device 524. According to either alternative configuration, an object can thereby be scanned at a first 3D printer device 504 and sent for printing at a second (i.e., distant) 3D printer device 524. A copy of the object can thereby be figuratively transported from one location to another.

Referring now to FIG. 5A, a representative peer-to-peer network configuration 550 is shown. A 3D printer scanner device 552 is shown in communication with a smart phone 554 via wireless (or wired) connection 553. Information collected by the smart phone 554 is then communicated via wireless (or wired) link 556 to a telecommunications network 560. This network can include for instance, a cloud network, a computing network, a cellphone network, and/or traditional phone network. A peer device 564 on the other end of the telecom network 560 can then be associated with the telecom network to receive the information. In this instance, a receiving smart phone 562 is configured to receive the information via wireless (or wired) connection 557. The smart phone 562 can then send the information to a receiving 3D printer scanner device 564 via wireless (or wired) connection 563. In the present context, a peer-to-peer network will provide the ability to share vast amounts of data between 3D printer scanner devices that are located all over the world. 3D printer file information can be readily transferred between peer machines, and therefore updates and improvements to the 3D printer files can be readily shared. Peers in the network can share disk storage, processing power, and network bandwidth without the need for a centralized administrative system.

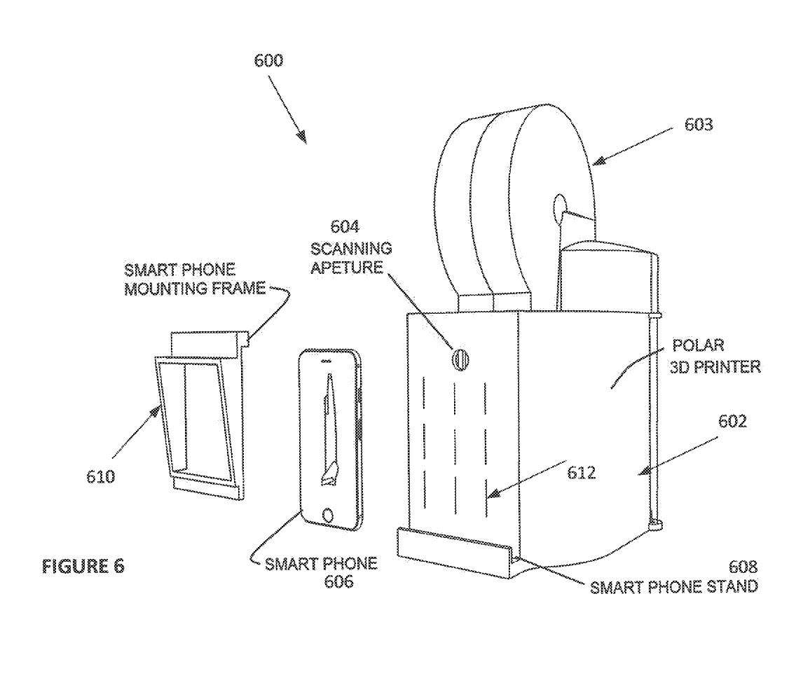

Referring now to FIG. 6, a representative 3D printer and scanning device configuration 600 is shown. The 3D printer 602 is shown to include the filament cartridge 603 mounted in a position per the descriptions above. The 3D printer 602 is also shown to include a scanning aperture 604 that aligns with the camera of a smart phone 606. The aperture 604 is placed so that it has a centerline view of the object scanning area. The aperture could also be in the form of a window or other such opening to allow placement of the smart phone for scanning The printer also includes a smart phone stand 608 located proximate to the base of the 3D printer in order to support the phone in a scanning position. The stand 608 can be integrally formed as part of the printer 602, or it can be a separate component. The rear facing camera of the smart phone would most often be used because it is usually a higher resolution imaging device. If the front facing camera of the smart phone is to be used, then slits 612 can be provided in the body of the 3D printer body so that light from the touch screen can be projected onto the object through the slits. This light can be emitted across the entire face of the touch screen, or the light can be emitted in patterns that align and correspond with the slits 612. This light will thereby assist in the illumination of the scanned object and provide a better scan result.

Alternatively and additionally, a smart phone mounting frame 610 can be used which would assist in holding the smart phone in position against the 3D printer so that the camera aligns with the scanning aperture 604. This mounting frame 610 can be configured to attach or hang on the upper edge or lip of the 3D printer frame to secure the upper portion of the smart phone in the proper position.

Similar to the prior described operation, the user can perform a scan by placing or temporarily fixing the object to be scanned onto the rotating platform. The user would then start the app on the smart phone that controls the 3D printer and scanning device. The app begins to collect images, while also streaming G code commands to the 3D printer and scanning device in order to synchronously rotate the platform. The rotation of the platform facilitates the smooth and controlled collection of images including all vertical sides of the object that is being scanned.

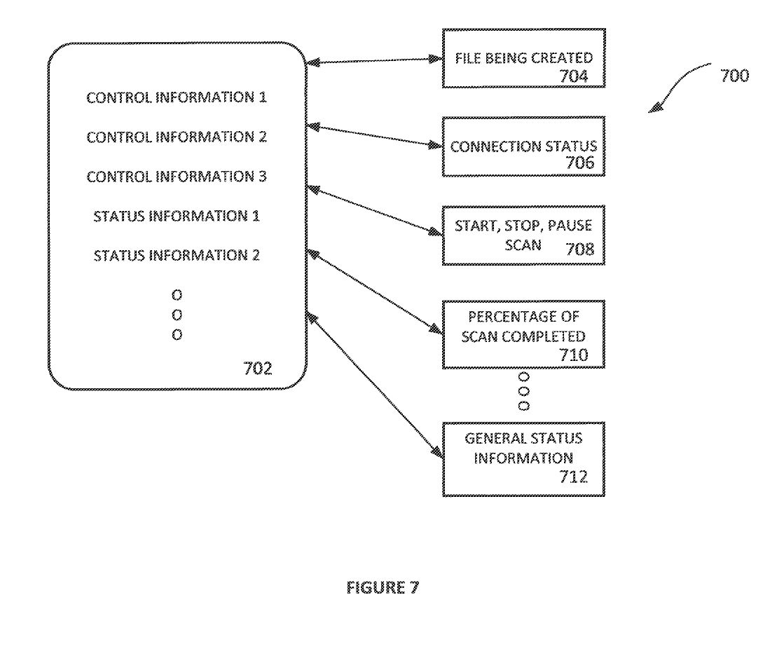

The touch screen of the smart phone can serve as the control panel for the scanning operation. As a result, any of a variety of information (for instance, status and control) could be displayed or conveyed via the touch screen. Referring now to FIG. 7, a representative set of information 700 is shown. The touch screen 702 is shown to generally convey control information 1, control information 2, control information 3, and so forth. The screen 702 can also convey status information 1, status information 2, and so forth. Examples of the corresponding type of information are shown to include: File being created 704—the file resulting from the scan can be identified and tracked, i.e., whether it is stored on the smart phone device, or on a cloud based service; Connection status 706—the smart phone needs to be in good communication with the 3D printer in order to control motion of the platform and complete a viable scan; Start, Stop, and Pause Scan 708—here the user can be provided with touch screen buttons to initiate and control the progression of the scan; Percentage of the scan completed 710—the user will be able to track the relative progress of the scan; General Status Information 712—any of a variety of other status information might be similarly provided. The touch screen can further provide swiping type control actions, along with multiple finger type actions such as pinch and rotation, in order to provide a user with full interactive control over the scanning operation.

While this invention has been described in terms of several preferred embodiments, there are alterations, permutations, modifications, and various substitute equivalents, which fall within the scope of this invention. It should also be noted that there are many alternative ways of implementing the system, elements, and devices of the present invention. It is therefore intended that the following appended claims be interpreted as including all such alterations, permutations, and various substitute equivalents that fall within the true spirit and scope of the present invention.

What is claimed is:

1. A 3D printing and scanning system that enables scanning of an object using a 3D printer device in association with a portable image capture device, the system comprising:
a 3D printer device having a rotatable platform for holding an object to be scanned;
a portable image capture device proximally associated with the 3D printer device;
a control signal communicated from the portable image capture device to the 3D printer device for controlling the rotation of the platform while a scan of the object is being performed by the portable image capture device; and
a 3D printer file resulting from the scan.

2. The 3D printing and scanning system of claim 1, further comprising an aperture in the 3D printer device for allowing scanning access by the portable image capture device of an object placed on the rotatable platform.

3. The 3D printing and scanning system of claim 2, further comprising at least one holding device to assist in aligning and holding the portable image capture device in the proper position during scanning

4. The 3D printing and scanning system of claim 1, further comprising file processing software for performing 3D printer processing operations on the 3D printer file.

5. The 3D printing and scanning system of claim 4, wherein the file processing software runs on the portable image capture device.

6. The 3D printing and scanning system of claim 4, further comprising a cloud service for storing the 3D printer file.

7. The 3D printing and scanning system of claim 6, wherein the file processing software is cloud based software for performing 3D printer processing operations on the 3D printer file.

8. The 3D printing and scanning system of claim 7, further comprising a network of receiving devices associated with the cloud service.

9. The 3D printing and scanning system of claim 8, wherein the network of receiving devices includes other portable image capture devices or 3D printers.

10. The 3D printing and scanning system of claim 9, wherein an object can be scanned on one 3D printer and sent through the cloud service to be printed on another 3D printer.

11. The 3D printing and scanning system of claim 1, wherein the portable image capture device includes a smart phone.

12. The 3D printing and scanning system of claim 11, wherein the touch screen of the smart phone is used to interactively convey control and status information regarding the scan being performed.

13. The 3D printer and scanning system of claim 12, wherein the scan being performed is controlled via touch screen gestures.

14. The 3D printer and scanning system of claim 13, wherein the touch screen gestures include one or more of touching, swiping, or multi-finger commands

15. The 3D printing and scanning system of claim 1, wherein the 3D printer device is a polar coordinate device.

16. The 3D printing and scanning system of claim 1, wherein the 3D printer device is a Cartesian coordinate device with a rotatable object platform.

17. The 3D printing and scanning system of claim 1, further comprising a 3D object holder to provide stable support of an object placed for scanning on the rotatable platform.

18. A 3D scanning and printing apparatus that enables a 3D scanning operation to be performed on the printer in association with coupled 3D image scanning device, the apparatus comprising:
a 3D printer having a rotatable platform and being configured to receive commands to rotate the platform in response to a scan being performed; and
a detachably coupled 3D image scanner associated with the 3D printer, the scanner configured to generate commands to rotate the 3D printer platform in response to a scan being performed.

19. The 3D scanning and printing apparatus of claim 18, further comprising a cloud service associated with the apparatus.

20. The 3D scanning and printing apparatus of claim 18, wherein a 3D printer file is produced from the 3D scanning operation and stored in the cloud service.

21. The 3D scanning and printing apparatus of claim 20, wherein the stored 3D printer file can be used by other devices connected to the cloud service.

22. A 3D scanning and printing method that enables a 3D scanning operation to be performed on a 3D printer that is associated with a 3D image scanning device, the method comprising the steps of:
placing an object to be scanned on a rotating platform of the 3D printer;
coupling a 3D image scanning device to the 3D printer;
generating commands to be sent from the 3D image scanning device to the 3D printer for controlling motion of the rotating platform;
scanning the object with the 3D image scanning device; and
outputting a 3D printer file.

23. The 3D scanning and printing method of claim 22, further comprising the step of:
storing the 3D printer file in a cloud based environment.

24. The 3D scanning and printing method of claim 23, further comprising the steps of:
accessing the 3D printer file from other devices connected to the cloud based environment.

25. The 3D scanning and printing method of claim 22, further comprising the step of:
sharing the 3D printer file via a peer-to-peer network.
